(19) United States
(12) Patent Application Publication
(10) Pub. No.: US 2016/0034905 A1
(43) Pub. Date: Feb. 4, 2016

(54) BROADCASTING INCIDENT RESOLUTION INFORMATION TO SERVICE DESK STAFF MEMBERS

(71) Applicant: CA, Inc., (US)

(72) Inventor: Robin Hopper, Prague (CZ)

(73) Assignee: CA, Inc., Islandia, NY (US)

(21) Appl. No.: 13/887,607

(22) Filed: May 6, 2013

(51) Int. Cl. G06Q 30/00

(52) U.S. Cl. CPC G06Q 30/016

(57) ABSTRACT

A service desk is managed by broadcasting a symptom and a root cause of a customer incident to service desk staff members. In response to receiving input of a service desk staff member, the symptom and the root cause of the customer incident may be stored in a personal knowledge base of the service desk staff member. A personal memory trigger may also be received from the service desk staff member, and the personal memory trigger may also be stored in the personal knowledge base. The personal memory trigger may include free-form text that has meaning to the service desk staff member relative to a given incident. The symptom and root cause of a customer incident may be retrieved from the personal knowledge base of the service desk staff member in response to receiving at least some of the free-form text from the service desk staff member.

### BACKGROUND

Various embodiments described herein relate to computer systems, methods and program products and, more particularly, to service desk management computer systems, methods and program products.

A service desk, also commonly referred to as a “help desk”, is a resource that provides a customer or end user with information and support related to a business enterprise's products and/or services. The service desk can troubleshoot problems and/or provide guidance about products, such as a computers, electronic equipment, food, apparel and/or software. Business enterprises may provide help desk support to their customers through various channels, such as toll-free telephone numbers, websites, instant messaging, email and/or other channels.

Service desk management systems, methods and computer program products, collectively referred to herein as a “service desk manager”, are used to manage and control the operation of a service desk. For example, a service desk manager may provide the communications interfaces with customers and provide logging of incidents that are reported by customers, along with symptoms of the incidents that are reported by the customers. The service desk manager may also provide routing of incidents to user terminals of service desk staff members, and may facilitate communication of incident resolution information, such as a root cause of a symptom, the disposition of the incident and/or any analysis information. A knowledge base may be provided to log incidents and their resolution, as well as other information.

### BRIEF SUMMARY

Various embodiments described herein can provide systems, methods and/or computer program products for managing a service desk, by broadcasting a symptom and a root cause of a customer incident to user terminals of service desk staff members, for example to user terminals of service desk staff members who are not associated or involved with the customer incident. Moreover, in response to receiving an input from a user terminal of a service desk staff member, the symptom and the root cause of the customer incident may be stored in and retrieved from a personal knowledge base of the service desk staff member.

In other embodiments, a personal memory trigger may also be received from the user terminal of the service desk staff member, and the personal memory trigger may also be stored in the personal knowledge base of the service desk staff member. The personal memory trigger may comprise free-form text that has meaning to the service desk staff member relative to a given incident. According to other embodiments, the symptom and root cause of a customer incident may be retrieved from the personal knowledge base of the service desk staff member in response to receiving at least some of the free-form text from the user terminal of the service desk staff member.

Accordingly, various embodiments described herein can distribute knowledge of an incident and its resolution to other service desk staff members. Various embodiments described herein can also provide personalized storage and retrieval of selected incidents and their resolutions based on a personal memory trigger of a service desk staff member.

In some embodiments, the service desk staff members comprise service desk agents and service desk problem managers, and the symptom and the root cause of the customer incident may be broadcast to user terminals of the service desk agents and/or the service desk problem managers. Moreover, in some embodiments, only a subset of the customer incidents may be broadcast. For example, only critical incidents, often referred to as “severity one incidents”, may be broadcast.

Various embodiments described above have included a personal memory trigger in connection with broadcasting of a symptom and root cause of a customer incident. However, personal memory triggers may also be used independent of a broadcast in other embodiments described herein. For example, some embodiments described herein manage a service desk by storing a personal memory trigger that is associated with a customer incident in a personal knowledge base of a service desk staff member. A symptom and a root cause of the customer incident may also be stored in the personal knowledge base of the service desk staff member. The personal memory trigger may comprise free-form text, and the symptom and the root cause of the customer incident may be retrieved from the personal knowledge base of the service desk staff member in response to receiving at least some of the free-form text from a user terminal of the service desk staff member.

It will be understood that various embodiments have been described above in connection with methods of managing a service desk. However, various other embodiments described herein can provide a service desk managing computer system that can be used to broadcast a symptom and a root cause of a customer incident to user terminals of service desk staff members, to allow storing of customer incidents in a personal knowledge base of a service desk staff member, to allow storing of a personal memory trigger, and/or to allow retrieval based on a stored personal memory trigger according to any of the embodiments described herein. Analogous service desk management computer program products may also be provided according to any of the embodiments described herein.

It is noted that aspects described herein with respect to one embodiment may be incorporated in different embodiments although not specifically described relative thereto. That is, all embodiments and/or features of any embodiments can be combined in any way and/or combination. Moreover, other systems, methods, and/or computer program products according to embodiments will be or become apparent to one with skill in the art upon review of the following drawings and detailed description. It is intended that all such additional systems, methods, and/or computer program products be included within this description, be within the scope of the present disclosure, and be protected by the accompanying claims.

### BRIEF DESCRIPTION OF THE DRAWINGS

The accompanying drawings, which are included to provide a further understanding of the present disclosure and are incorporated in and constitute a part of this application, illustrate certain embodiment(s). In the drawings:

FIG. 1 is a block diagram of a service desk according to various embodiments described herein.

FIG. 2 is a block diagram of a service desk manager according to various embodiments described herein.

FIG. 3 is a schematic diagram of a knowledge base of a service manager according to various embodiments described herein.

FIGS. 4-6 are flowcharts of operations that may be performed by a service desk manager according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

It will be understood that, although the terms first, second, etc, may be used herein to describe various elements, these elements should not be limited by these terms. These terms are only used to distinguish one element from another. For example, a first element could be termed a second element, and, similarly, a second element could be termed a first element, without departing from the scope of the various embodiments described herein. As used herein, the term “and/or” includes any and all combinations of one or more of the associated listed items.

The terminology used herein is for the purpose of describing particular embodiments only and is not intended to be limiting to other embodiments. As used herein, the singular forms “a”, “an” and “the” are intended to include the plural forms as well, unless the context clearly indicates otherwise. It will be further understood that the terms “comprises,” “comprising,” “includes” and/or “including”, “have” and/or “having” when used herein, specify the presence of stated features, integers, steps, operations, elements, and/or components, but do not preclude the presence or addition of one or more other features, integers, steps, operations, elements, components, and/or groups thereof. In contrast, the term “consisting of” (and variants thereof) when used in this specification, specifies the stated features, integers, steps, operations, elements, and/or components, and precludes additional features, integers, steps, operations, elements and/or components. Elements described as being “to” perform functions, acts and/or operations may be configured to or other structured to do so. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which various embodiments described herein belong. It will be further understood that terms used herein should be interpreted as having a meaning that is consistent with their meaning in the context of this specification and the relevant art and will not be interpreted in an idealized or overly formal sense unless expressly so defined herein.

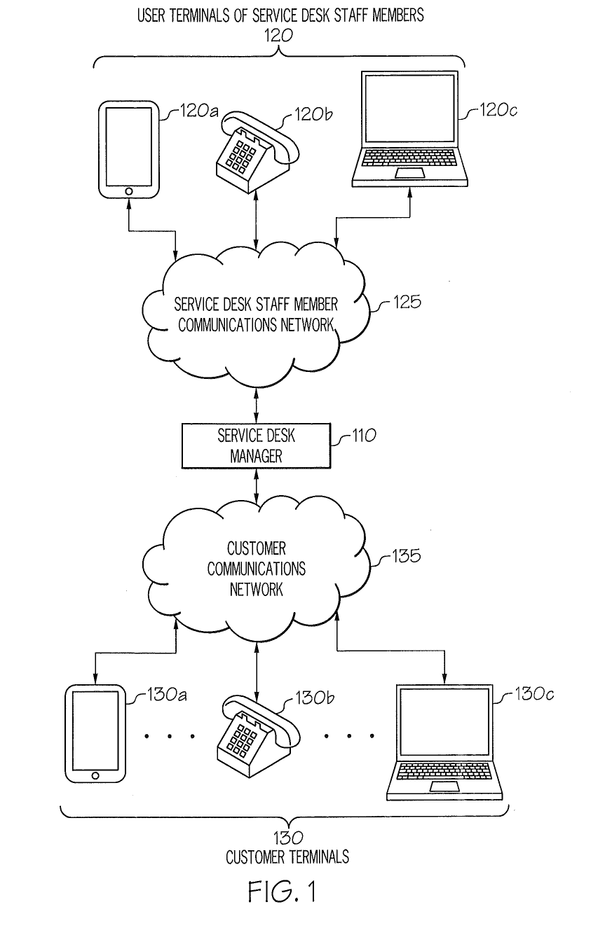

FIG. 1 is a block diagram of a service desk according to various embodiments described herein. Referring to FIG. 1, the service desk includes a service desk manager 110 that communicates with a plurality of customers at customer terminals 130 via, for example, a customer communications network 135. The service desk manager 110 also communicates with a plurality of user terminals of service desk staff members 120, also referred to herein as “staff member terminals” 120, via a service desk staff member communications network 125.

The customer terminals 130 may include tablets and/or smart phones 130a, wire line telephones 130b, laptop and/or desktop computers 130c and/or any other user terminal. Different customer terminals may belong to different customers. Multiple terminals 130 may belong to a given customer and/or all of the customer terminals 130 may belong to a given business enterprise in an “internal service desk” environment. In general, each of the customer terminals 130 may be embodied by one or more enterprise, application, personal, pervasive and/or embedded computers, such as a desktop, notebook, net book, laptop, smart phone, electronic book reader, game console and/or any other embedded device. Moreover, a given customer may own one or more customer terminals 130 of various configurations and/or may use a customer terminal that is owned or controlled by another entity.

The user terminals of service desk staff members 120 may include tablets and/or smart phones 120a, wire line telephones 120b, laptop and/or desktop computers 120c and/or any other staff member terminal. Different staff member terminals may belong to different staff members. Multiple terminals 120 may belong to a given staff member and/or all of the terminals 120 may belong to a given business enterprise that provides a service desk. In general, each of the staff member terminals 130 may be embodied by one or more enterprise, application, personal, pervasive and/or embedded computers, such as a desktop, notebook, net book, laptop, smart phone, electronic book reader, game console and/or any other embedded device. Moreover, a given staff member may own or use one or more staff member terminals 120 of various configurations and/or may use a staff member terminal 120 that is owned or controlled by another entity, such as the entity that provides the service desk.

Some or all of the staff member terminals 120 may be physically located in a common location, such as a customer call center, and/or may be distributed over many locations, such as at many call centers. In other embodiments, the staff member terminals 120 need not be included in a call center, but, rather, may be geographically dispersed in a “virtual call center” environment.

The customer communications network 135 and the service desk staff member communications network 125 may be embodied by any conventional, public and/or private, real and/or virtual, wired and/or wireless network including all or a portion of the global communications network known as the Internet, and may include various types of tangible, non-transitory computer readable medium. Moreover, the two networks 125 and 135 may overlap at least in part.

The service desk manager 110 provides management functions for a service desk, including functionality according to various embodiments described herein. The service desk manager 110 may be embodied in a standalone unit or may be contained as part of other computing infrastructure, such as a client-server and/or cloud computing environment. The service desk manager 110 may be embodied as one or more enterprise, application, personal, pervasive and/or embedded computer systems that are operable to receive, transmit, process and store data using any suitable combination of software, firmware and/or hardware and that may be standalone or interconnected by any conventional, public and/or private, real and/or virtual, wired and/or wireless network including all or a portion of the global communication network known as the Internet, and may include various types of tangible, non-transitory computer readable medium. The service desk manager 110 may also include a network transceiver, processor, memory and/or other circuitry.

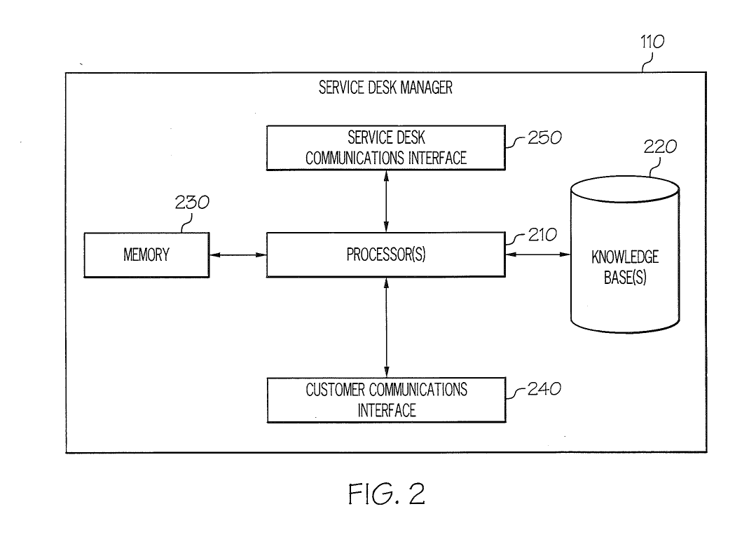

FIG. 2 is a block diagram of a service desk manager, such as the service desk manager 110 of FIG. 1, according to various embodiments described herein. The service desk manager 110 may include one or more processors 210, one or more memory devices 230, one or more knowledge bases 220, a customer communications interface 240 and a service desk communications interface 250.

Processor(s) 210 are configured to execute computer program code from memory device(s) 230, to perform at least some of the operations and methods described herein, and may comprise any conventional or special purpose processor, including a Digital Signal Processor (DSP), Field Programmable Gate Array (FPGA), Application-Specific Integrated Circuit (ASIC) and/or multi-core processors, Memory devices 230 may include nonvolatile storage, such as a hard disk drive, flash memory and/or like devices that may store computer program instructions and data on computer-readable media, and/or one or more volatile memory devices, such as random access memory. The customer communications interface 240 and the service desk member communications interface 250 allow data to be transferred between the service desk manager 110 and external devices. These interfaces may include modem, network interfaces (such as an Ethernet card), a communications port, a PCMCIA slot and card, telephone interfaces and/or the like. Data transfer via the communication interfaces 240 and 250 may be in the form of signals, which may be electronic, electromagnetic, optical and/or other signals capable of being received by the communications interfaces 240 and 250. These signals may be provided to communications interfaces 240 and 250 via a communications path that may be implemented using wire or cable, fiber optics, a phone line, a cellular phone link, an RF link and/or other communications channels.

Still referring to FIG. 2, one or more knowledge bases 220 are also included. The knowledge base(s) may reside on memory devices 230, or may be at least partially separate therefrom, and may be embodied using database management systems.

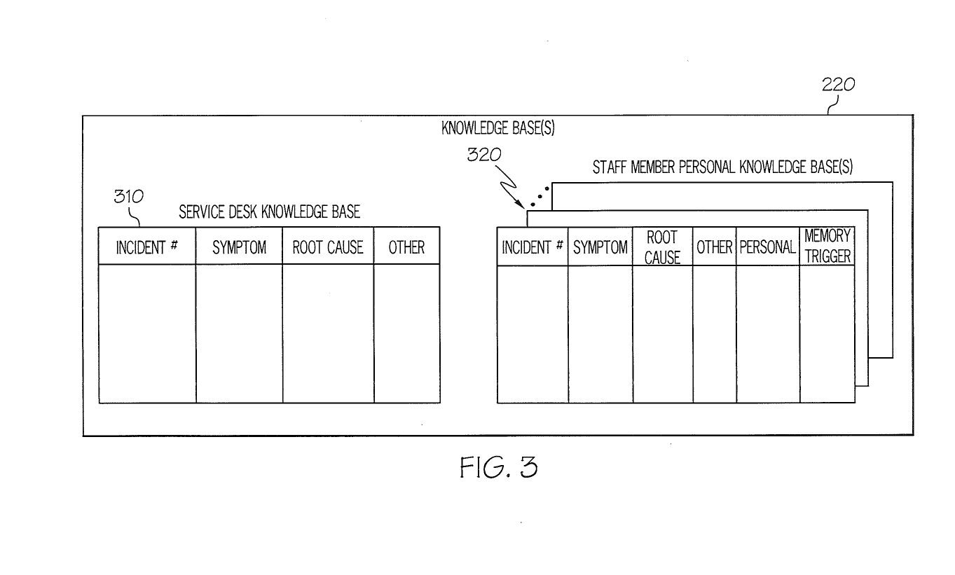

FIG. 3 illustrates a layout of knowledge bases, such as knowledge bases 220 of FIG. 2, according to various embodiments described herein. The knowledge bases 220 may include a service desk knowledge base 310 and a staff member personal knowledge base 320 for a respective service desk staff member. As shown in FIG. 3, the service desk knowledge base 310 may log incidents and their resolution information. The incidents may be logged according to an “incident #”. A “symptom” describes information provided by the customer about the incident. Resolution information may include a “root cause” that has been determined by the service desk staff members for the symptom that is reported by the incident number. Other information may include other resolution information, such as a “disposition” of the incident and/or other items of “analysis” that may be relevant to the resolution of the incident. The service desk knowledge base 310 may also include other data related to incidents and/or the general management of the service desk. It will also be understood that the service desk knowledge base 310 may be embodied by a plurality of related knowledge bases.

According to various embodiments described herein, a staff member personal knowledge base 320 is also provided for a respective service desk staff member. A respective staff member knowledge base 320 may include a selected incident number and its related symptom, root cause and, in some embodiments other information, and also may include a personal memory trigger for the incident. The use of the staff member personal knowledge bases 320 will be described in greater detail below.

It will be understood that the knowledge bases of FIG. 3 are illustrated as tables, but may be embodied as linked lists, object classes and/or other conventional database formats. Moreover, the staff member personal knowledge bases 320 are illustrated as being separate knowledge bases in FIG. 3. However, in other embodiments, the staff member knowledge bases 320 may be appended to the service desk knowledge base and/or may contain one or more links or references to various data elements of the service desk knowledge base 310, Thus, in some embodiments, a single knowledge base may be provided to embody all the elements of FIG. 3.

Various embodiments described herein can distribute knowledge of an incident and its resolution to other service desk staff members. Various embodiments described herein can also provide personalized storage and retrieval of selected incidents and their resolutions based on a personal memory trigger of a service desk staff member.

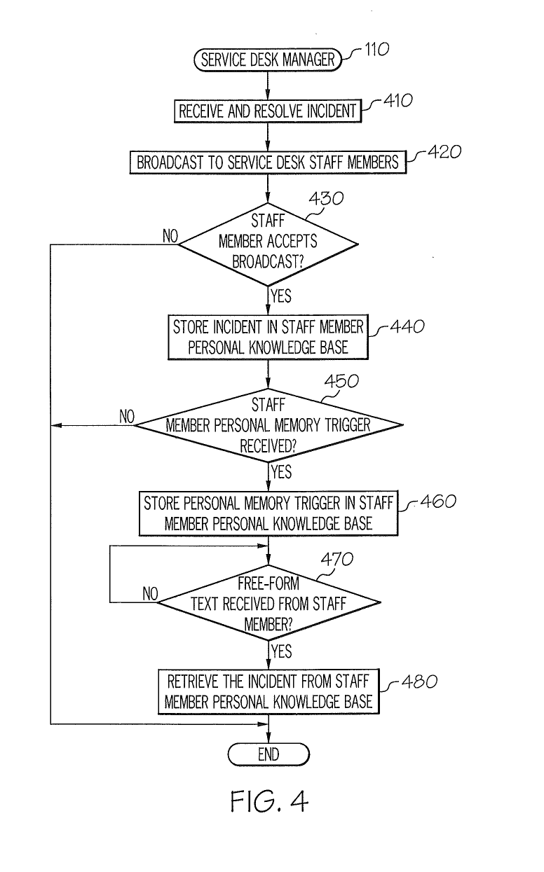

FIG. 4 is a flowchart of operations that may be performed by a service desk manager, such as the service desk manager 110 of FIG. 1 or 2, according to various embodiments described herein. Referring now to FIG. 4, at Block 410, an incident is received, for example from one or more of the customer terminals 130 via the customer communications network 135, and is logged in, for example under an incident #. Using conventional service desk management techniques, the incident may be assigned to a service desk staff member at a staff member terminal 120 by the service desk manager 110. The service desk staff member may receive the incident, for example by obtaining the symptoms and other customer identification information, and may also resolve the incident by, for example, performing analysis, identifying a root cause of the customer incident and identifying a disposition of the customer incident.

In some embodiments, the same customer desk staff member may receive and resolve the incident at Block 410. However, in other embodiments, a service desk may be arranged in a hierarchical manner, where “Tier 1 Agents” or “Service Desk Agents” are focused on receiving the incident and its description. Resolution of the incident, including analysis, root cause identification and/or disposition may be performed by “Tier 2 Agents”, also referred to as “Service Desk Problem Managers”. In some embodiments, a third tier support organization may also be provided to advise and solve very difficult problems. The results of receiving and resolving the incident may be stored in a knowledge base, such as the service desk knowledge base 310 of FIG. 3.

Referring now to Block 420, a symptom and a root cause of a customer incident is broadcast to user terminals of service desk staff members 120. The service desk staff members who receive the broadcast may include service desk staff members who are not associated with the customer incident. Accordingly, knowledge of incidents and their resolutions may be broadcast or distributed to other service desk staff members, so that they can use this knowledge in resolving new incidents that come in.

Additional discussion of the broadcast operations of Block 420 of FIG. 4 will now be provided. In particular, in some embodiments, a symptom and a root cause of a customer incident is broadcast to user terminals of service desk members. Additional resolution information, such as disposition or analysis information, may also be broadcast, as well as other information. In some embodiments, the symptom and root cause of a customer incident may be broadcast to user terminals of all service desk staff members. However, in other embodiments, the broadcasting may only be selectively performed to user terminals of service desk agents and/or user terminals of service desk problem managers. Moreover, in yet other embodiments, the broadcasting may take place only to user terminals of service desk staff members who are not associated with the customer incident.

In still other embodiments, broadcasting of all customer incidents may overload the ability of the service desk staff members to absorb the information. Thus, in some embodiments, symptoms and root causes of only a subset (i.e., one or more but less than all) of the customer incidents are broadcast. The subset selection may be made based upon severity of the customer incidents. For example, only customer incidents that consist of “critical incidents” may be broadcast. In still other embodiments, “interesting” incidents that may be of value to the service desk staff members may be broadcast, whether or not they are critical incidents. Other subset selection criteria may be used, including specification by service desk management personnel and/or by individual service desk staff members. For example, when a service desk staff member concentrates on resolving issues related to hard drive failures, only those incidents relating to hard drive failures may be broadcast to that staff member. These incidents may be specified by service desk management personnel and/or by the individual service desk staff member selection from a predefined list and/or using other filtering criteria.

Still referring to FIG. 4, optionally, at Block 430, a staff member input may be received at the staff member terminal 120, to indicate, for example, a desire of the staff member to accept the broadcast and save the broadcast symptom and root cause of the customer incident in a personal knowledge base, such as a staff member personal knowledge base 320 of FIG. 3. The staff member input of Block 440 may include selection of a broadcast message for acceptance and saving from a list of broadcast messages, entry of a command to save the broadcast symptom and root cause of a specific customer incident in the staff member's personal knowledge base 320, selection by key word searching, input of preselected criteria by the staff member and/or other selection techniques. In response to receiving the input from the user terminal of the service desk staff member at Block 430, the symptom and root cause of the customer incident is stored in the personal knowledge base of the service desk staff member, such as a staff member personal knowledge base 320 of FIG. 3. On the other hand, if the staff member does not wish to accept the broadcast at Block 430, it is not saved and operations end.

It will be understood that the operation of storing the symptom and root cause of the customer incident in the personal knowledge base of the service staff member may be implemented by populating a separate staff member personal knowledge base 320. In other embodiments, a staff member personal knowledge base 320 may be linked to or associated with the corresponding incident, its symptom, root cause and/or other data in the service desk knowledge base 310, without the need to store a duplicate copy in the staff member personal knowledge base 320. Accordingly, if an incident is of interest to a given staff member, this incident may be stored in a personal knowledge base of the staff member for later retrieval.

Still referring to FIG. 4, at Block 450, an optional personal memory trigger may also be received from the staff member. The personal memory trigger may be received in response to a prompt when the staff member indicates a desire to store the symptom and root cause of the customer incident in the staff member personal knowledge base, or may occur independent of a prompt. At Block 460, optionally, in response to receiving the personal memory trigger from the user terminal of the service desk staff member at Block 450, the personal memory trigger is stored in the personal knowledge base of the service desk staff member. In some embodiments, this storing may take place by storing the personal memory trigger in the service desk knowledge base 310 along with a link to the staff member, rather than storing in a separate staff member knowledge base 320. On the other hand, if a personal memory trigger is not received at Block 450, the operations end, so that the incident will be saved at Block 440 without saving a personal memory trigger.

Additional discussion of personal memory triggers of Blocks 450 and 460 will now be provided. The personal memory trigger may comprise free-form text and may include any word, phrase or other text that can be used as a personal memory trigger of the incident for the service desk staff member, so as to allow the incident to be retrieved based upon the personal memory trigger that is stored. For example, the personal memory trigger may include a phrase, such as “This incident took place on my birthday”, “This incident took place during the big snowstorm”, “This is the flash-crash incident”, “I was listening to the song ‘Desolation Row’ when this incident came in”, “This caused Bill to have a breakdown”, or “Our manager was yelling that we're losing thousands of dollars every minute the system is down”. Moreover, any other mnemonic device, such as a word that rhymes with the incident name may be used. More generically, any personal association that will help the staff member remember this incident will be stored. The personal memory trigger may also include images, sounds and/or multimedia content in other embodiments.

Continuing with the description of FIG. 4, optionally, some or part of the free-form text may be received from a staff member at Block 470. In response, at Block 480, the incident may be retrieved from the staff member personal knowledge base based on the free-form text input. Accordingly, the symptom and the root cause of the customer incident may be retrieved from the personal knowledge base of the service desk staff member in response to receiving at least some of the free-form text (or other aspect) of the personal memory trigger from the user terminal of the service desk staff member. Conventional database searching of, for example, the “memory trigger” field of the staff member's personal database 320 may be used to identify the incident based on the personal memory trigger.

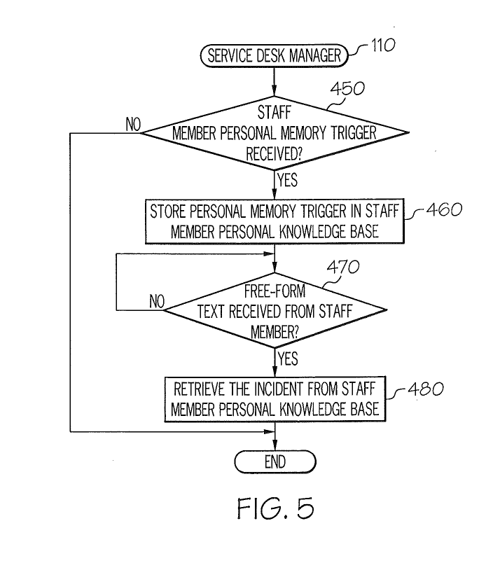

In FIG. 4, a personal memory trigger is used as part of the process of broadcasting, storing and retrieving a broadcast symptom and root cause of a customer incident. However, according to other embodiments described herein, the personal memory trigger may be used independent of broadcasting a symptom and a root cause of a customer incident. Thus, as shown in FIG. 5, the operations of Blocks 450, 460, 470 and 480 may be used relative to any incident, which need not be broadcast by the service desk manager, but, rather, may be an incident that was individually handled by the service desk staff member or which may have been described to the service desk staff member by a colleague.

Indeed, embodiments of FIG. 5 may be used in environments outside the service desk environment, where a personal memory trigger may be used to assist in recalling any information that is stored in a database. Thus, a personal memory trigger may be associated with one or more items of a database or other file system, to facilitate later retrieval.

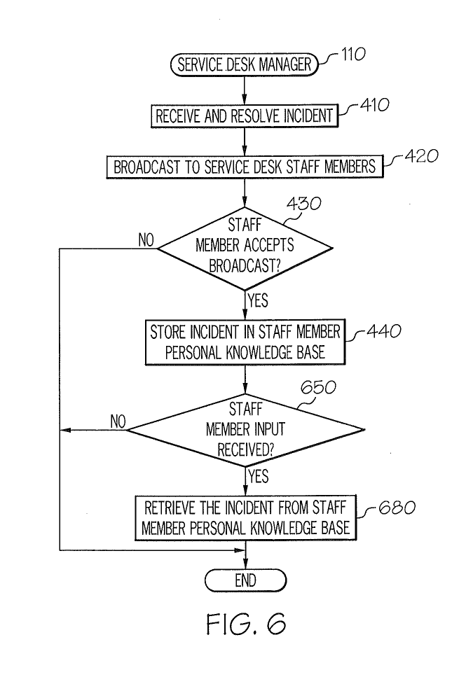

Moreover, in FIG. 4, retrieval of an incident from the staff member personal knowledge base is based on an earlier memory trigger that was provided. However, retrieval of an incident from the staff member personal knowledge base may take place independent of the use of a personal memory trigger. For example, as illustrated in FIG. 6, operations of Blocks 410, 420, 430 and 440 are performed to store an incident in a staff member personal knowledge base. Then, referring to Block 650, a staff member input is received. The staff member input may be any input that may be used to provide retrieval from a knowledge base. For example, staff member input of Block 650 may include one or more key words, selection from a list of incidents that are stored in the staff member knowledge base, selection of a specific date or time range and/or any other database retrieval input criteria. At Block 680, the incident is retrieved from the staff member personal knowledge base based on the staff member input that was received at Block 650. Thus, retrieval may take place independent of the use of a personal memory trigger.

Additional discussion of various embodiments described herein will now be provided. In particular, service desk personnel may log incidents, but may not be informed about the underlying root cause of the incident, or other aspects of incident resolution. In addition, with high workloads, it may be desirable to provide a simple way of remembering previous incidents and their root causes. Various embodiments described herein can allow service desk staff members to record symptoms of an incident with its root cause, along with some personal information that acts as a personal memory trigger. Thus, root cause analysis may be linked to some personal information about the incident, to help service desk staff members remember when similar incidents occur in the future.

In some embodiments, for “severity one” incidents, when the root cause has been identified, the symptoms of the incident and the root cause will be individually broadcast to the service desk staff members. The service desk staff member has the opportunity to either save the broadcast to their individual knowledge base, or to discard the broadcast. While saving, the service desk staff member may be asked to save a memory trigger with the broadcast, for example, “Warehouse down for two hours”, “Ship could not unload cargo for three hours”, “Bob in Finance was completely stressed out”. Then, if a similar incident happens in the future, there is a chance that at least one person at the service desk will have a “memory trigger” and link some personal situation with a technical resolution from their own knowledge base. Accordingly, various embodiments described herein can help service desk agents to recall technical solutions by linking them to a personal memory trigger.

As will be appreciated by one of skill in the art, various embodiments described herein may be embodied as a method, data processing system, and/or computer program product. Furthermore, embodiments may take the form of a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computer environment or offered as a service such as a Software as a Service (SaaS).

Some embodiments are described herein with reference to flowchart illustrations and/or block diagrams of methods, systems and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

In the drawings and specification, there have been disclosed typical embodiments and, although specific terms are employed, they are used in a generic and descriptive sense only and not for purposes of limitation, the scope of the disclosure being set forth in the following claims.

1. A method of managing a service desk comprising:
broadcasting a symptom and a root cause of a customer incident to user terminals of service desk staff members;
storing the symptom and the root cause of the customer incident in a personal knowledge base of a service desk staff member in response to receiving an input from a user terminal of the service desk staff member;
storing a personal memory trigger in the personal knowledge base of the service desk staff member and associating the personal memory trigger with the symptom and the root cause of the customer incident in the personal knowledge base of the service desk staff member in response to receiving the personal memory trigger from a user terminal of the service desk staff member, wherein the personal memory trigger comprises free-form text that associates a personal memory of the service desk staff member with the customer incident; and
retrieving the symptom and the root cause of the customer incident from the personal knowledge base of the service desk staff member in response to receiving at least some of the free-form text that is included in the personal memory trigger, from the user terminal of the service desk staff member.

2.-5. (canceled)

6. A method according to claim 1 wherein the service desk staff members comprise service desk agents and service desk problem managers and wherein the broadcasting comprises broadcasting the symptom and the root cause of the customer incident to user terminals of the service desk agents and/or the service desk problem managers.

7. A method according to claim 1 wherein the service desk is configured to process a plurality of customer incidents and wherein the broadcasting comprises broadcasting symptoms and root causes of a subset of the plurality of customer incidents to the user terminals of service desk staff members.

8. A method according to claim 7 wherein the subset of the customer incidents consists of critical customer incidents.

9. A method according to claim 1 wherein the user terminals of service desk staff members comprise user terminals of service desk staff members who are not associated with the customer incident.

10. A method of managing a service desk comprising:
storing a personal memory trigger that is associated with a customer incident in a personal knowledge base of a service desk staff member, wherein the personal memory trigger comprises free-form text that associates a personal memory of the service desk staff member with the customer incident;
storing a symptom and a root cause of the customer incident in the personal knowledge base of the service desk staff member; and
retrieving the symptom and the root cause of the customer incident from the personal knowledge base of the service desk staff member in response to receiving at least some of the free-form text that is included in the personal memory trigger, from a user terminal of the service desk staff member.

11.-13. (canceled)

14. A computer program product for managing a service desk, comprising:
a tangible non-transitory computer readable storage medium comprising computer readable program code embodied in the medium that when executed by at least one processor causes the at least one processor to perform operations comprising:
broadcasting a symptom and a root cause of a customer incident to user terminals of service desk staff members;
storing the symptom and the root cause of the customer incident in a personal knowledge base of a service desk staff member in response to receiving an input from a user terminal of the service desk staff member;
storing a personal memory trigger in the personal knowledge base of the service desk staff member and associating the personal memory trigger with the symptom and the root cause of the customer incident in the personal knowledge base of the service desk staff member in response to receiving the personal memory trigger from a user terminal of the service desk staff member, wherein the personal memory trigger comprises free-form text that associates a personal memory of the service desk staff member with the customer incident; and
retrieving the symptom and the root cause of the customer incident from the personal knowledge base of the service desk staff member in response to receiving at least some of the free-form text that is included in the personal memory trigger, from a user terminal of the service desk staff member.

15.-18. (canceled)

19. A computer program product according to claim 14 wherein the service desk is configured to process a plurality of customer incidents and wherein the broadcasting comprises broadcasting symptoms and root causes of a subset of the plurality of customer incidents to the user terminals of service desk staff members.

20. A computer program product according to claim 14 wherein the user terminals of service desk staff members comprise user terminals of service desk staff members who are not associated with the customer incident.
